(19) United States
(12) Patent Application Publication
(10) Pub. No.: US 2014/0314939 A1
(43) Pub. Date: Oct. 23, 2014

(54) Herbal soft drink

(71) Applicant: Arati Sinha, Salt lake City, UT (US)

(72) Inventor: Arati Sinha, Salt lake City, UT (US)

(21) Appl. No.: 13/865,508

(22) Filed: Apr. 18, 2013

(51) Int. Cl. A23L 2/02; A23L 2/52

(52) U.S. Cl. CPC A23L 2/02; A23L 2/52
USPC 426/599

(57) ABSTRACT

The subject beverage is the refreshing and pleasant taste attributes of a lemony soft drink, the flavors of mint and fennel, and the medicinal values of all the natural ingredients, all in one. Mint is known for soothing the stomach and alleviating symptoms of indigestion in more than one ways and fennel helps relieving stomachaches and stimulating digestion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

Soft Drink/Herbal Beverage

### BRIEF SUMMARY OF THE INVENTION

It is a completely natural, refreshing and pleasant tasting, herbal soft drink with no artificial flavors or preservatives.

### BRIEF DESCRIPTION OF THE SEVERAL DRAWING VIEWS

Not Applicable

### DETAILED DESCRIPTION OF THE INVENTION

Ingredients:
2 oz. or 2 cups of fresh mint leaves
2 table spoons of whole fennel seed
1 cup Fresh lemon Juice
1 cup Fresh lime Juice
2% cups of Sugar
16 cups (1 gallon) of Water

Process:
Grind finely the mint leaves and fennel seeds with the lime and lemon juices in a blender;
Add the water & mix thoroughly;
Chill and shake before consuming.

1. The selection of ingredients in the beverage

2. The proportion of the ingredients in the beverage
